(19) United States
(12) Patent Application Publication
(10) Pub. No.: US 2017/0147537 A1
(43) Pub. Date: May 25, 2017

(54) Method, apparatus and system for reproducing a document defined in a page description language

(71) Applicant: CANON KABUSHIKI KAISHA, Tokyo (JP)

(72) Inventors: ANDREW R. COKER, Macquarie Park (AU); DAVID NATHAN RIESEL, North Bondi (AU); JUN LIU, Dundas (AU); PETER VINCENT WYATT, Hunters Hill (AU)

(21) Appl. No.: 15/357,983

(22) Filed: Nov. 21, 2016

(30) Foreign Application Priority Data
Nov. 23, 2015 (AU) 2015258332

(51) Int. Cl. G06F 17/21; G06F 3/12; G06T 3/40

(52) U.S. Cl. CPC G06F 17/218; G06T 3/4092; G06F 3/1248; G06F 3/125

(57) ABSTRACT

A method of reproducing a document defined in a page description language (PDL) data structure. The PDL data structure defining content of the document including marked content is received. The PDL data structure comprises an authoring intent data structure defining an output constraint for reproducing the marked content. The authoring intent data structure is interpreted to determine whether reproducing the marked content in accordance with received user input would violate said output constraint. The document including the marked content is reproduced in a form which satisfies the output constraint by processing the marked content in isolation from the other content of the document using the authoring intent data structure if reproducing the marked content violates the output constraint.

### CROSS-REFERENCE TO RELATED APPLICATIONS

The present application claims the benefit of Australian Patent Application No. 2015258332, filed Nov. 23, 2015, entitled “METHOD, APPARATUS AND SYSTEM FOR REPRODUCING A DOCUMENT DEFINED IN A PAGE DESCRIPTION LANGUAGE”, the content of which is expressly incorporated by reference herein in its entirety.

### TECHNICAL FIELD

The present invention relates to documents formatted in a page description language (PDL) and, in particular, to encoding an author intent associated with a portion of page content, for the reproduction of the documents. The present invention also relates to a method, apparatus and system for reproducing a document, and to a computer program product including a computer readable medium having recorded thereon a computer program for reproducing a document.

### BACKGROUND

Page description languages offer a convenient, device-independent means for utilising and sharing documents for a wide variety of uses. Page description languages also offer the ability to view document content without requiring a software application in which the document itself was originally created. A document author may export application-specific content into an application-independent page description language format, such as the Portable Document Format (PDF) as defined by International Standard Organisation (ISO) standard, ISO 32000-1:2008. In doing so, the document author creates a serialised, static snapshot of the document content, forming a PDL document authored for a specific display size. For example, a document page in PDF format provides a media box defining paper size on which to ideally output graphical content of that page.

Although a native page size can be defined within a PDL document, there are often other factors and conditions present requiring the document page content to be displayed at an output size different to that originally intended by the document author. For example, a user may request document pages to be printed in an n-up style (with multiple pages imposed on a single sheet of paper). As another example, a document may be displayed on a device with a small screen, or a document may be projected onto a screen that is physically distant from an audience of observers. In such scenarios, document page content may be displayed at a size which differs from an original intended size of an author, at which the content is no longer legible, or no longer fulfils a design principle or legal requirement intended by the document author.

One method for ensuring that document content remains legible at reduced page display sizes is to inspect a defined text size for all text content on the document pages. The method then prohibits page reduction that would reduce text sizes to fall below a certain limit, below which it is deemed that text is no longer legible. Such a method relies on heuristics, and may not accurately reflect the original intentions of the document author.

Many methods for ensuring that document content remains legible may also prohibit the entire document or an entire page to be displayed at a certain size, even when only a subset of the document content is affected by legibility concerns at the reduced size. For certain configurations of page content, such an overly strict prohibition against reduced size page display, reduces a benefit that could be otherwise attained. For example, a benefit of reduced paper consumption enabled when printing a document in an n-up page layout configuration.

Thus, there is a need to enable the reproduction of documents in accordance with the intent of an author, while simultaneously gaining a benefit (such as reduced paper usage) associated with a display modality in which document content is displayed at a size other than intended by the author.

### SUMMARY

It is an object of the present invention to substantially overcome, or at least ameliorate, one or more disadvantages of existing arrangements.

Disclosed are arrangements in which semantically related content is denoted into a single unit by means of markers within a page content stream. The unit is associated with an author intent data structure defining constraints on the output display size for content within the marked section. The author intent data structure may be used to control the size to which pages are reduced. Pages may be drawn at a smaller size but with the particular marked portion of affected content processed in isolation and reproduced (e.g., displayed, re-displayed, printed, projected) separately.

According to one aspect of the present disclosure, there is provided a computer readable medium comprising a page description language data structure stored thereon, the page description language data structure comprising:

a page content stream of commands for drawing content of a document on an output medium in accordance with a user input, the page content stream having a marked content section defining marked content to be displayed on the output medium in accordance with an authoring intent; and

an authoring intent data structure associated with the marked content section to reproduce the document on the output medium based on the authoring intent and the user input, the authoring intent data structure defining an output constraint to allow the marked content to be reproduced in accordance with the authoring intent in isolation from the rest of the page content stream if the user input violates the output size constraint for the at least one marked object.

According to another aspect of the present disclosure, there is provided a method of reproducing a document defined in a page description language (PDL) data structure, the method comprising:

receiving the PDL data structure defining content of the document including marked content, the PDL data structure comprising an authoring intent data structure defining an output constraint for reproducing the marked content;

interpreting the authoring intent data structure to determine whether reproducing the marked content in accordance with received user input would violate said output constraint; and

reproducing the document including the marked content, wherein the marked content is reproduced in a form which satisfies said output constraint by processing the marked content in isolation from the other content of the document using the authoring intent data structure if reproducing the marked content violates the output constraint.

According to still another aspect of the present disclosure, there is provided an apparatus for reproducing a document defined in a page description language (PDL) data structure, the apparatus comprising:

module for receiving the PDL data structure defining content of the document including marked content, the PDL data structure comprising an authoring intent data structure defining an output size constraint for reproducing the marked content;

module for interpreting the authoring intent data structure to determine whether reproducing the marked content in accordance with received user input would violate said output size constraint; and

module for reproducing the document including the marked content, wherein the marked content is reproduced in a form which satisfies said output size constraint by processing the marked content in isolation from the other content of the document using the authoring intent data structure if reproducing the marked content violates the output size constraint

According to still another aspect of the present disclosure, there is provided a system for reproducing a document defined in a page description language (PDL) data structure, the system comprising:

a memory for storing data and computer program;

a processor coupled to the memory for executing said compute program, said computer program comprising instructions for:
receiving the PDL data structure defining content of the document including marked content, the PDL data structure comprising an authoring intent data structure defining an output size constraint for reproducing the marked content;
interpreting the authoring intent data structure to determine whether reproducing the marked content in accordance with received user input would violate said output size constraint; and
reproducing the document including the marked content, wherein the marked content is reproduced in a form which satisfies said output size constraint by processing the marked content in isolation from the other content of the document using the authoring intent data structure if reproducing the marked content violates the output size constraint.

According to still another aspect of the present disclosure, there is provided a computer readable medium having a computer program stored thereon for reproducing a document defined in a page description language (PDL) data structure, the computer program comprising:

code for receiving the PDL data structure defining content of the document including marked content, the PDL data structure comprising an authoring intent data structure defining an output size constraint for reproducing the marked content;

code for interpreting the authoring intent data structure to determine whether reproducing the marked content in accordance with received user input would violate said output size constraint; and

code for reproducing the document including the marked content, wherein the marked content is reproduced in a form which satisfies said output size constraint by processing the marked content in isolation from the other content of the document using the authoring intent data structure if reproducing the marked content violates the output size constraint.

Other aspects are also disclosed.

### BRIEF DESCRIPTION OF THE DRAWINGS

One or more embodiments of the invention will now be described with reference to the following drawings, in which:

FIGS. 1A and 1B form a schematic block diagram of a general purpose computer system upon which arrangements described can be practiced;

FIG. 2A shows a zoomed-in view of example document page content of a document page;

FIG. 2B shows the entire document page of FIG. 2A including the document page content of FIG. 1A;

FIG. 2C shows a view of the document page of FIG. 2A, and other document pages of the same document imposed at a smaller output display size than the size for which the document page was designed;

FIG. 3A shows a detailed view of a part of an example page;

FIG. 3B shows a further example document page, having a marked content section including drawing commands for producing a text graphic object;

FIG. 3C shows yet a further example document page, having a marked content section including drawing commands for producing vector graphics;

FIG. 3D shows the example document pages of FIGS. 3A, 3B and 3C displayed at a reduced size on a single sheet of printed paper;

FIG. 4 shows a subtended viewing angle of projected document content;

FIG. 5A shows an example output page;

FIG. 5B shows a projector and projector screen displaying a document page;

FIG. 5C shows a first view of an example document page displayed within the user interface of a smartphone;

FIG. 5D shows a second view of the example document page of FIG. 5C displayed within the user interface of the smartphone;

FIG. 6 is a schematic flow diagram showing a method of displaying page content conforming to an author intent;

FIG. 7 is a schematic flow diagram showing a method of processing page content;

Appendix A shows an example page content stream; and

Appendix B shows another example page content stream where a property /constraints of a property list associated with a marked content section defines display output constraints.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Electronic documents may be defined in a device-independent form by utilising page description languages such as PDF (Portable Document Format) as defined by International Standard Organisation (ISO) standard, ISO 32000-1:2008. In PDF, documents are defined as a series of document pages, and are defined declaratively as a series of page description language (PDL) data structures and data streams. Declared PDL data structures represent various objects such as document pages, document properties, and reusable resources utilised throughout the document such as images and fonts.

Objects may reference data provided as a data stream, where each page object may reference one such data stream defining the page content for a document page. Page content streams consist of a series of drawing commands for producing the graphical content displayed as a page of the document. Drawing commands may store or overwrite a parameter value in the graphics state, or may cause an actual drawing command to be executed, using previously stored (or default) drawing parameters in the current graphics state. For example, the graphics state stores a current fill colour and stroke colour for vector graphics, a line thickness, styles for drawing joined lines, and a current font, text size (i.e., glyph size for the text) and style. Furthermore, the graphics state may be stored, temporarily modified, and then restored to a previously stored state.

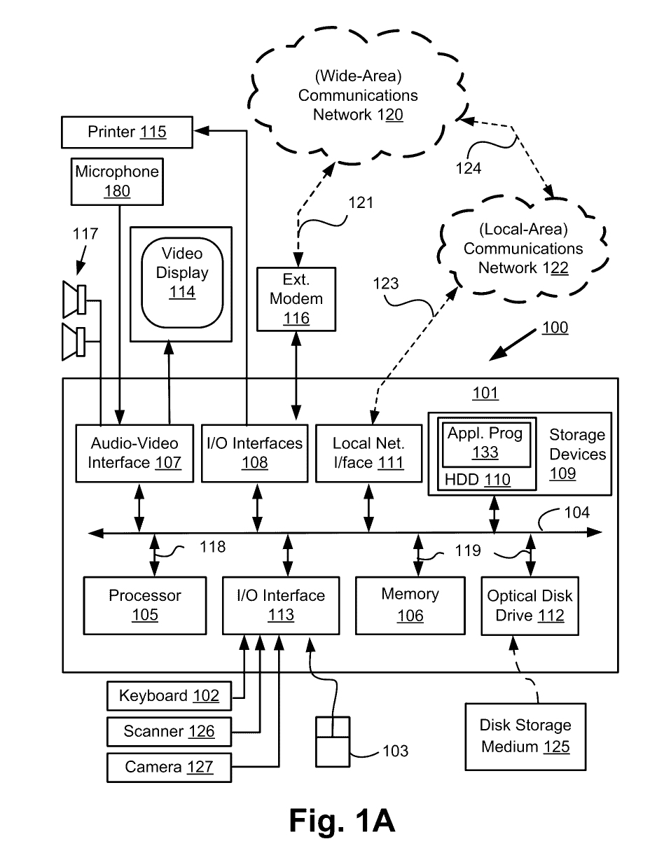

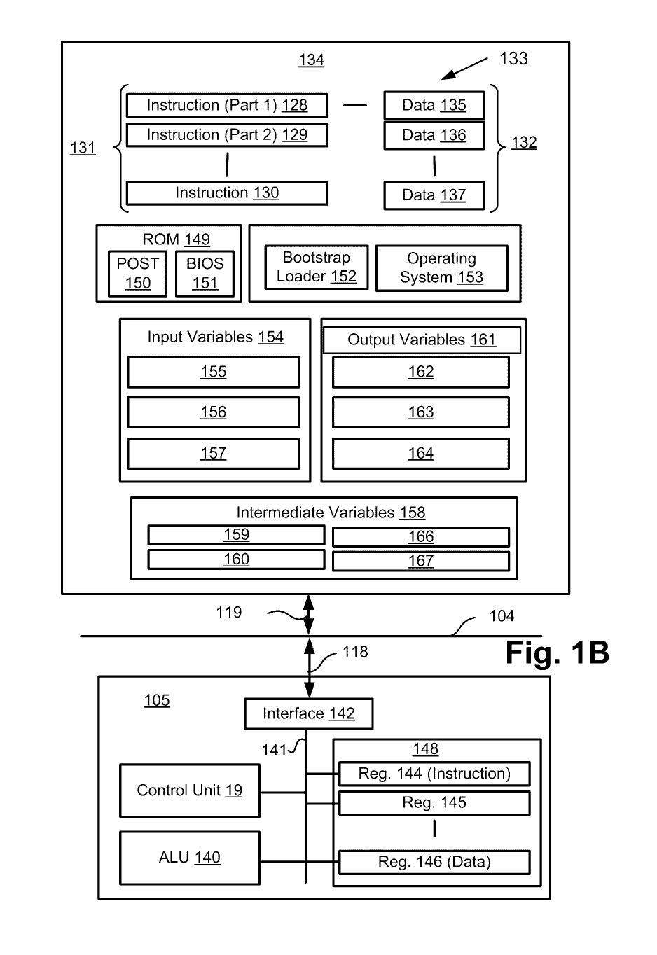

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems. Nevertheless, methods to be described may below may also be performed on lower-level devices such as, for example, a mobile phone, a tablet device, a portable media player or a digital camera, in which processing resources are limited.

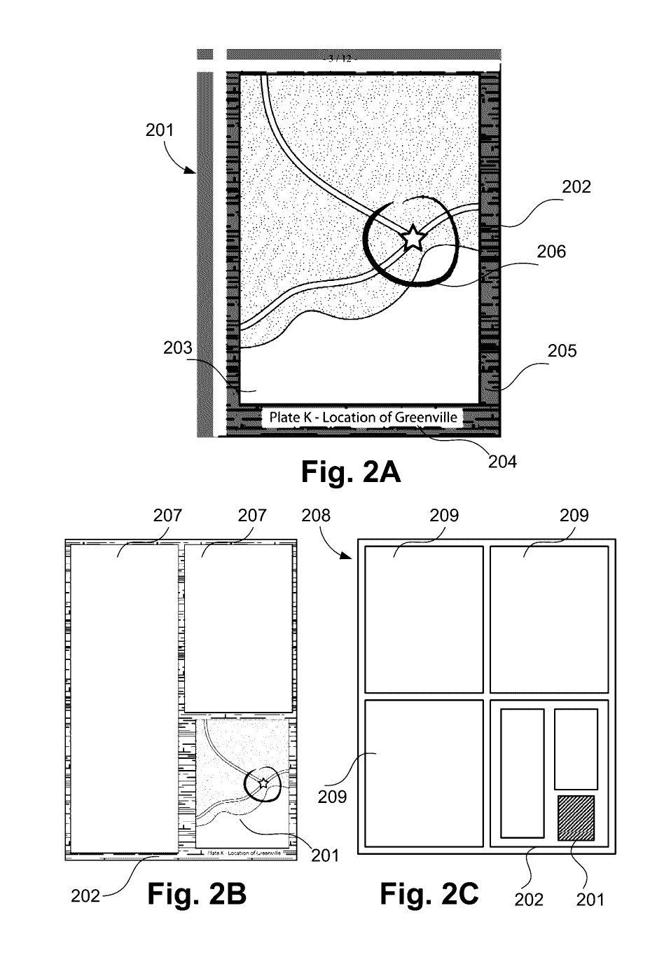

Methods described below may be implemented using the computer system 100 wherein the processes of FIGS. 2A to 7, to be described, may be implemented as one or more software application programs 133 executable within the computer system 100. In particular, the steps of the described methods are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 133 is typically stored in the HDD 110 or the memory 106. The software is loaded into the computer system 100 from the computer readable medium, and then executed by the computer system 100. Thus, for example, the software 133 may be stored on an optically readable disk storage medium (e.g., CD-ROM) 125 that is read by the optical disk drive 112. A computer readable medium having such software or computer program recorded on the computer readable medium is a computer program product. The use of the computer program product in the computer system 100 preferably effects an advantageous apparatus for implementing the described methods.

In some instances, the application programs 133 may be supplied to the user using one or more CD-ROMs 125 with the application programs 133 stored thereon. The CD-ROMs 125 may be read via the corresponding drive 112. Alternatively the application programs 133 may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed arrangements use input variables 154, which are stored in the memory 134 in corresponding memory locations 155, 156, 157. The disclosed arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:

a fetch operation, which fetches or reads an instruction 131 from a memory location 128, 129, 130;

a decode operation in which the control unit 139 determines which instruction has been fetched; and

an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

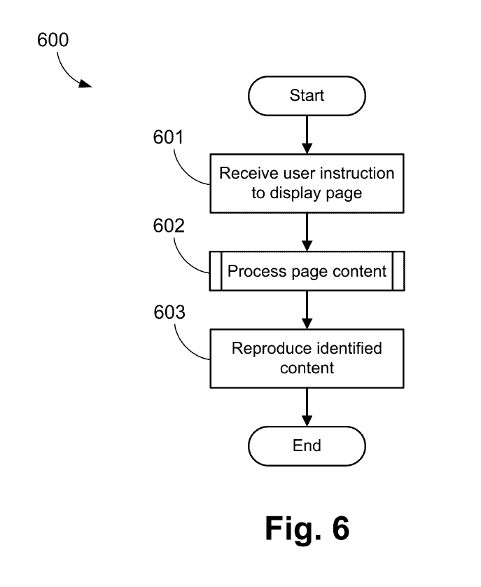

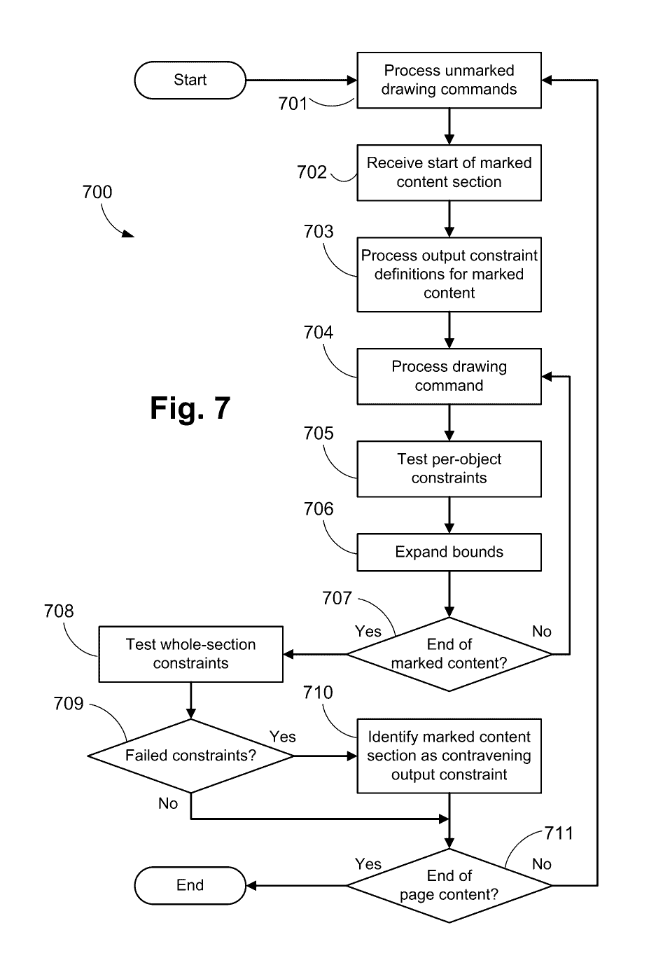

Each step or sub-process in the processes of FIGS. 6 and 7 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The described method may alternatively be implemented in dedicated hardware such as one or more integrated circuits performing the functions or sub functions of described methods. Such dedicated hardware may include graphic processors, digital signal processors, or one or more microprocessors and associated memories.

FIGS. 2A, 2B and 2C show a number of views of an example semantic unit of page content 201 on an example document page 202.

FIG. 2A shows a detailed zoomed-in view of the example semantic unit of page content 201, comprising a drawing of a map 203, and a caption 204. The map 203 comprises various drawing elements such as lines, text and filled shapes. The map 203 and caption 204 form a single unit of semantic content, where the map 203 and caption 204 are related in terms of location on the page 202, and in terms of meaning within the thematic context of the page content 201. Thus, if the document page content 201 is modified, those items within a single unit of semantic content (e.g., map 203 and caption 204) should be modified as a single unit. The page content appearing on document page 202 also has drawing commands for displaying a page background 205 and a map annotation 206, which in the example of FIG. 2A are not considered semantically related to the unit of semantic content 201.

FIG. 2B shows the entire example document page 202 including the combined map and caption semantic unit 201, and some typeset columns of additional (but semantically distinct) content 207. In the example of FIGS. 2A to 2B, the document page 202 has been designed for a particular output display size (i.e., the paper size and orientation encoded within the page properties for document page 202), with the author intention that the drawing of the map and caption 201 shall be sufficiently large as to be legible when the document page 202 is produced at that intended size.

FIG. 2C shows a view of the document page 202, and other document pages 209 of the same document imposed at a smaller output display size than the size for which the document page 202 was designed. In FIG. 2C, a sequence of four document page images are imposed onto a single output page 208. In the example viewing context of FIGS. 2A to 2C, the user has issued a command (e.g., by inputting the command using the input devices 102, 103) to produce displayed output at a size which is smaller than that originally intended by the author of the document page 202.

FIG. 2C indicates stylistically, by means of shading (i.e., for explanation purposes), that the example unit of semantic page content 201 is output at a size at which the unit of semantic page content 201 is no longer legible—the detail of the shapes, lines and text (i.e., glyphs for the text) is no longer displayed at a size at which the author of the document judges that the content 201 will serve as legible and useful content.

In addition to concerns of legibility of text and graphical elements, a document author may be under an obligation to conform to legislative requirements. For example, the document author may be under an obligation regarding the size of text used in contracts and other legal documents, or for disclosure of facts in advertising. A document prepared for one purpose may have different output size requirements than a document prepared for another purpose. Therefore, rather than operating under a general heuristic for legibility concerns, the display requirements and intentions of the author may be encoded in the document itself.

Furthermore, the display requirements of the author of a document may differ between instances of a particular type of document content. For example, text objects for a section heading should remain at least at a certain size in order to fulfil the function as a heading, which is a different size than for text in a regular paragraph. Therefore, the display requirements and intents of the author may be encoded such that separate semantic object groups may be associated with separate display requirement records.

There exists a variety of output display modalities in which the content of a document, defined in some page description language, can be reproduced for consumption by a user. A display modality may be described by the physical medium by which the document content is displayed, and by the type of interaction possible between users of that display and the displayed content itself. Traditional printed documents represent one such display modality, being printed on one or two sides of a series of physical sheets of paper. Interaction with printed documents is very limited. For example, a user may request a document (or set of document pages) to be printed at a certain size, which is then permanent. Displaying documents on the screen of a mobile computing device is a different display modality with different characteristics of the display medium and possible interaction modes. For example, the display is typically smaller, and with a less dense arrangement of pixels, than for documents printed on paper. However, the display modality is highly interactive (e.g., it is possible to zoom in and out of, and pan between different views and orientations of page content).

Document content projected on a large screen is yet another display modality with different characteristics to that of a mobile computing device. For example, in the case of projected document content it is generally not possible to physically bring a user closer to the display medium to inspect detailed content at close range—(i.e., the audience members are in fixed seats in an auditorium or meeting room). This contrasts with the display modality for printed documents, where a user may hold a paper document at close range in order to inspect small details. In the case of document content projected on a large screen, it may be inappropriate to interactively zoom in and out of detailed document content, as this viewing experience is shared between multiple viewing users in the audience who may find it distracting to observe interactive zooming directed by another user in that environment.

In the described methods, a document defined in accordance with a page description language (PDL) data structure comprises one or more pages, each page having a page dictionary and a page content stream. The page dictionary defines a page size at which the document author intends page content to be displayed. The page content stream comprises a series of drawing commands that, when executed in the order in which the drawing commands appear in the page content stream, produce drawn output reproducing the document page on an output medium. The graphical representation of a semantic unit of content on the page is produced by executing a series of drawing commands located contiguously within the page content stream. The contiguous series of drawing commands is identified as a semantic unit of content by means of special markers that denote the start and end of a marked content section. Other drawing commands, not semantically related to the item and not contained within the markers denoting the start and end of the marked content section, may produce other graphical output which occupies the same or partly the same area of the page, in front of or behind the item.

Furthermore, in one arrangement of the described methods, a set of contiguous drawing commands within the content stream of a document page may be enclosed by special marking commands denoting the start and end of a marked content section. A marked content section, thus denoted, is associated with an author intent dictionary which defines output constraints for the graphical page elements produced by drawing commands enclosed within the associated marked content section.

Appendix A shows an example page content stream, including drawing commands producing the graphical output shown for page 202 of the example in FIGS. 2A, 2B and 2C. The example of Appendix A utilise the PDF page description language. Some repetitive sections are omitted in the example of Appendix A for brevity. The /Constraints property associated with the marked content section is omitted in the example of Appendix A and described in detail further below.

In the example page content stream of Appendix A, the drawing commands for producing the semantically related map item (i.e., with its own caption) are enclosed within the commands BDC for starting a marked content section, and EMC for ending a marked content section. Prior to the marked content section, there are drawing commands for background or other elements. After the marked content section, there are further drawing commands for producing foreground elements, in the example of Appendix A being an annotation 206 drawn on top of the map. In the example of Appendix A, the document author has not designated the annotation 206 to be semantically grouped as the same item of content as the map itself.

The described arrangements and drawing command examples are provided in reference to the PDF page description language (PDL). However, the described methods may be implemented in other page description languages. The described methods may be implemented with different drawing commands and different terminology and means of expressing structural elements of a document, such as definitions of pages and their properties.

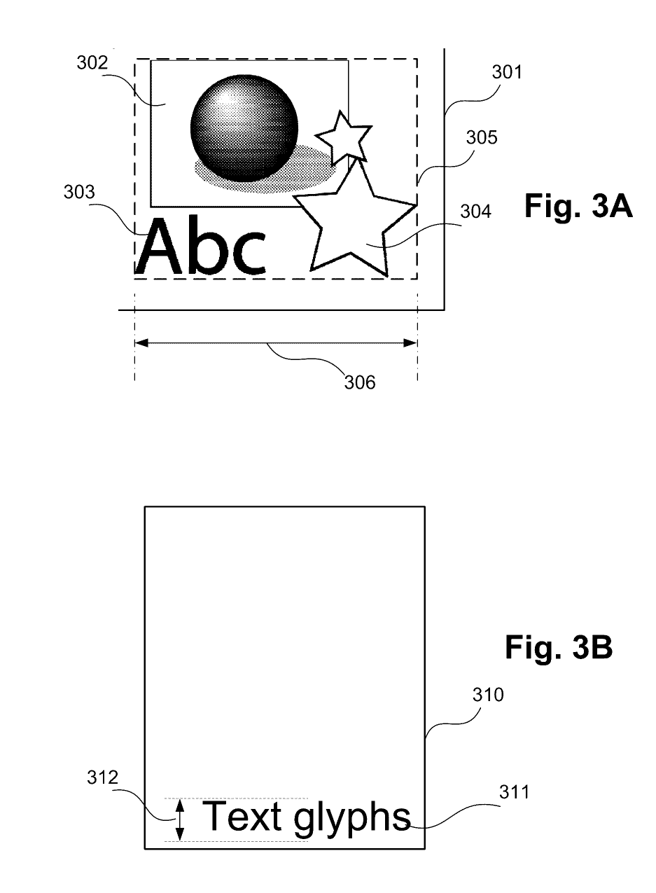

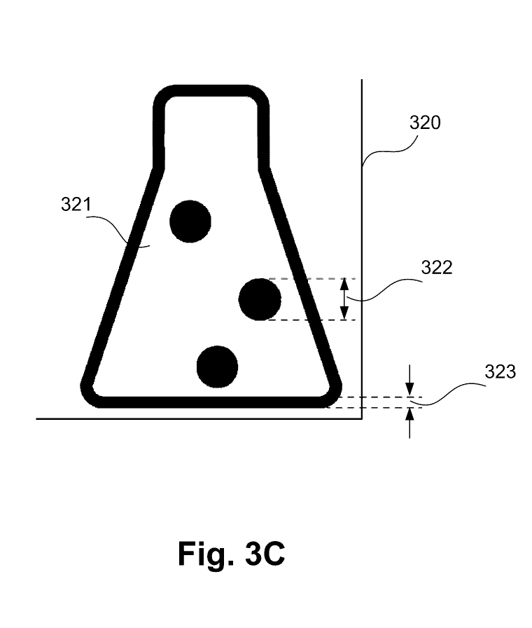

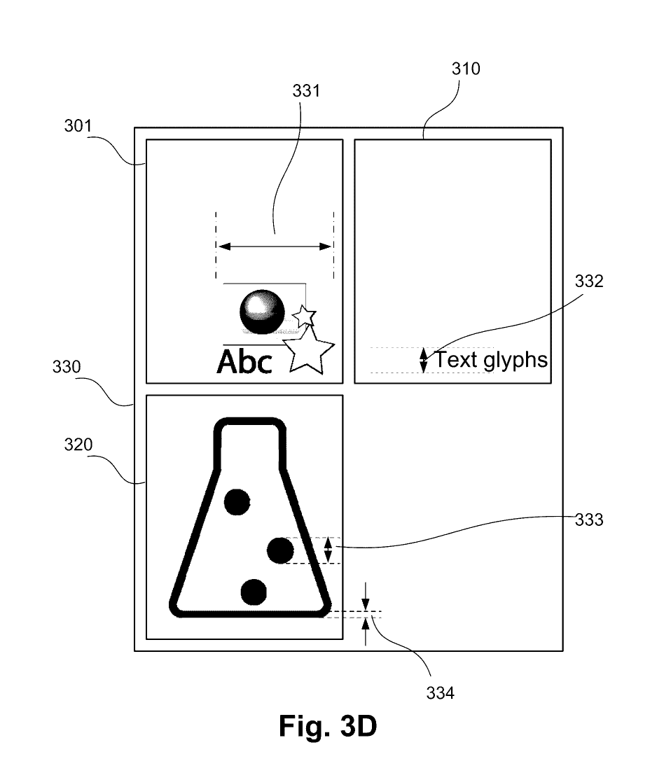

FIGS. 3A to 3C show a number of different methods of representing an output constraint within an author intent data structure associated with a marked content section within a page content stream. Each of FIGS. 3A, 3B and 3C show example document pages 301, 310 and 320, respectively, formed at an original author-intended output size, with output constraints represented in a number of ways. FIG. 3D shows the same example document pages 301, 310 and 320 displayed at a reduced size on a single sheet of printed paper (4-up printing) 330.

FIG. 3A shows a detailed view of a part of an example page 301. The example page 301 has a page content stream containing a marked content section with drawing commands for producing a plurality of objects including a raster bitmap graphic 302, a text graphic 303, and vector graphic objects 304 (some star shapes). An aggregate bounds 305 may be inferred from the size and placement of the constituent graphical objects 302, 303 and 304. An aggregate size metric 306 of the aggregate bounds may be further determined—in the example of FIG. 3A, the aggregate size metric is the width of the aggregate bounds. The document page 301 is displayed at reduced size on sheet 330, where the aggregate size metric of the marked content is some lesser size, 331.

According to an arrangement, an output constraint may be represented as a minimum size at which a unit of marked content may be displayed on the output medium. However, any suitable spatial characteristic of a unit of marked content may be used to represent the output constraint in the described methods, with various output constraints being described below. The described methods may be used for transforming marked content to satisfy such output constraints. The graphical objects including, for example, the raster bitmap graphic 302, the text graphic 303, and vector graphic objects 304 may be modified in reproduced marked content in accordance with such a transformation.

In another arrangement, an output constraint may be represented as a scaling ratio, such as a maximum amount of scale-down ratio (i.e., degree of reduction) as measured between an original defined size of marked content, and its size as displayed on an output medium. In still another arrangement, the output constraint is represented as a glyph size for text or a line stroke size for line objects. In one arrangement, the output constraint is associated with a display modality.

FIG. 3B shows a further example document page 310, having a marked content section including drawing commands for producing a text graphic object 311. The drawing commands for the text graphic object 311 include a command that sets a font point size, controlling the size 312 of the text graphic object 312 on the page 310. The document page 310 is displayed at reduced size on sheet 330, where the font size of the text graphic object on the output medium is some smaller size 332. According to one arrangement, an output constraint may be represented as a minimum effective font size at which a text graphic object produced by a drawing command within a unit of marked content may be displayed on an output medium.

FIG. 3C shows yet a further example document page 320, having a marked content section including drawing commands for producing vector graphics 321. The vector graphics 321, in the example of FIG. 3C, is comprised of stroked and filled vector shapes, having feature size metrics such as a stroke width 323 and an object size 322. The document page 320 is displayed at reduced size on sheet 330, whereon the feature size metrics of the vector graphics objects are some smaller sizes 333 and 334. According to an arrangement, an output constraint may be represented as a minimum feature size at which a vector graphic object produced by a drawing command within a unit of marked content may be displayed on an output medium.

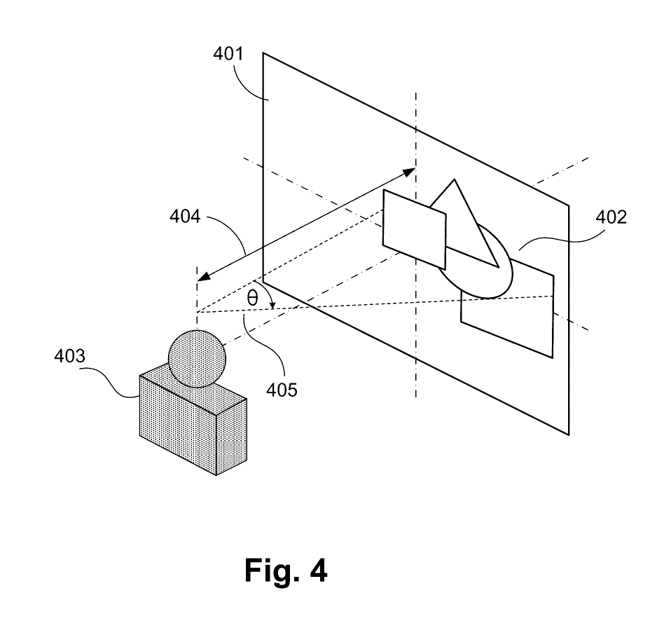

FIG. 4 shows a projector screen 401 being utilised as the output display medium for example displayed document page content, including a semantic unit of page content 402 (a group of geometric shapes), delineated as such by means of a marked content section in a page content stream for a displayed document page. An observer 403 is located at some distance 404 along an axis perpendicular to a front surface of the screen 401. The distance 404 is known, or is some ideal, abstracted or typical user viewing distance for the particular viewing context. A subtended viewing angle θ 405 of the marked content 402 may be determined by consideration of the fixed project screen size, the relative aggregate size of the marked content 402, and the viewing distance 404.

According to one arrangement, an output constraint may be expressed as a minimum subtended viewing angle, in aggregate, for graphical objects produced by drawing commands within a unit of marked content as displayed in a projected viewing context.

A drawing command within a page content stream of a document page may produce a raster bitmap graphical object. The drawing command also declares a size and placement of the raster bitmap on an output medium. In order to reproduce the raster bitmap data on the output medium as a bitmap graphical object, a sampling operation is performed mapping a contribution of pixel data provided in the raster bitmap data, to a set of pixel locations defined in the co-ordinate space of an output device (e.g., a display device). Depending on the resolution attributes of the output device of the viewing context, and on the resolution and size of the supplied raster bitmap data, it may be necessary to upscale or downscale the supplied raster bitmap data during this mapping operation. For example, in a viewing context consisting of a mobile computing device with a small display size, a document originally authored to be displayed at a commonly used paper size could be resized to fit the small display device such that bitmap graphic objects are drawn by subsampling the supplied bitmap data at a high rate. The resizing of the document may cause detail present in the bitmap data, and deemed important by the document author, to become hidden, become illegible, or become otherwise unsuitable for an intended use of the bitmap data. According to one arrangement, an output constraint may be represented as a limit on the subsampling rate required for displaying bitmap graphical objects produced by drawing commands within a unit of marked content.

In one arrangement, the authoring intent data structure is supplied as a PDF dictionary associated with a marked content section using a property list accompanying begin marked content command BDC. Each output constraint is recorded as a dictionary entry comprising a key and value. Appendix B shows an example, in which a property /Constraints of the property list associated with the marked content section defines output constraints expressed as a minimum aggregate artwork size, a maximum aggregate scale-down ratio, a minimum font point size, a minimum vector feature size, a minimum bitmap sampling rate, and a minimum subtended viewing angle. The set of possible output constraints that can be defined are mapped to a set of keys known to software for interpreting the page description language data structure. Actual drawing commands of the page content stream have been omitted for brevity.

In some arrangements, software applications (e.g., software application 133) for document creation automatically encode marked content sections with accompanying author intent data structure as part of the process of exporting a document. A document author using such software may explicitly identify certain page elements to have certain output constraints, by selecting page elements within a graphical user interface of a software application, by the application of rules, templates or filters, or other methods. Furthermore, a document author using such software may also explicitly identify an item, group or subset of page content to be a semantic unit for which the output constraints shall apply. For example, a user of a software application for authoring document content may assemble a document page having text and some drawing elements that form an illustration. The entire illustration may then be selected as a semantic unit of content, and a minimum display size for that illustration may be specified as an output constraint.

In other arrangements, the constraints can be associated with elements of a style sheet or template utilised by a document author within a document creation software application. By invoking particular styles or reusable elements in a template, the document author may indicate a particular author intent for display size of certain document elements, which are then exported in association drawing commands for that content. For example, a document author may utilise a style sheet for a legal document having an encoded style for legal contract terms, which automatically invoke an output constraint relating to displayed font size of text graphic objects. Furthermore, the style sheet may automatically denote a template section for the legal contract terms as a unit of semantic content to which the output constraints shall be applied.

The aforementioned method of encoding marked content sections with accompanying author intent data structure with output constraints, within a document page content stream, will now be further described by way of example. Specific marked page content that does not conform to the output constraints expressed in the author intent data structure may be separately reprocessed and redisplayed such that it does conform to the author intent. The redisplayed content is processed and displayed in isolation of other page content. The method described above provides advantages over methods that instead prohibit the entire page, or entire set of document pages, from being reproduced at a size for which only a subset of the page content is too small with the remainder of the page content is considered to have been reproduced at an acceptable size.

As described in more detail below, not only the marked content is reproduced in isolation of spatially neighbouring objects, the marked content is reproduced in isolation of foreground or background objects overlapping the marked content.

In a first example, which takes place in the viewing context of a printed document, the majority of the page content of a document may be acceptable printed at 4-up (i.e., with four slots for reduced-size logical document pages to be imposed on each sheet of printed output). In one arrangement, some of the page slots on some output sheets are utilised for redisplaying content items that contravene their associated output constraints at 4-up size. Thus, all document content is presented at a size indicated as being acceptable by the document author, while all document pages remain intact—related page content placed on the same page by the document author remains in the same vicinity when displayed.

In a further example, which takes place in the viewing context of an interactive presentation on a landscape-oriented projection screen, portrait-oriented document pages are presented at reduced size (i.e., in terms of subtended viewing angle) on one part of the screen surface. The remaining area of the screen is reserved for an interactive presentation view of each required unit of semantic content.

According to several advantageous arrangements, the drawing commands within a marked content section are reproduced in isolation of other content, even when that content is overlapping with or overlapped by graphic objects produced by other, unrelated drawing commands (i.e., commands not within the markers denoting the beginning and end of the marked content section). For example, the unit of semantic content depicting a map 203 in the example of FIG. 2A is overlapping with graphic objects for producing a background 205, and is in turn overlapped by graphic objects representing a map annotation 206 not intended by the document author as comprising part of the map 203 itself.

A method 600 of reproducing (e.g., displaying, redisplaying, printing, projecting) page content of a document will now be described with reference to FIG. 6. As described above, the document may be defined as a series of document pages, and may be defined declaratively as a series of page description language (PDL) data structures and data streams. The PDL data structure defining the page content of the document to be reproduced may be received by the processor 105 from memory 106, for example. The method 600 will be described by way of example where the PDL data structure defining the page content to be reproduced includes at least one marked content section defining marked content. The PDL data structure for the document also comprises authoring intent data structures associated with each marked content section defining one or more output constraints for reproducing marked content. The method 600 may be implemented as one or more software code modules of the software application 133 resident on the hard disk drive 110 and being controlled in its execution by the processor 105.

The method 600 begins at receiving step 601 at which a user input signal comprising a request to display a page is received under execution of the processor 105. The user input signal is associated with a request to display a page at a specific size or orientation on an output medium.

The method 600 then flows to processing step 602 at which the page content for the page display request is processed under execution of the processor 105. A method 700 of processing page content, as executed at step 602, will be described in detail below with reference to FIG. 7. As described in more detail below, the processing performed at step 602 is used for interpreting the authoring data structure associated with each marked content section to determine whether reproducing the marked content of a particular marked context section in accordance with received user input signal would violate any output constraints. As a result of processing the page content at step 602, one or more marked content sections may be identified as contravening the associated authoring intent data structure for that marked content section. For each such contravening marked content section, a graphics state at the beginning of the marked content section is retained so that the marked content section can be reproduced in isolation. Reproducing the marked content in isolation is enabled by retaining the graphics state at the beginning of the marked content. The graphics state may be stored in the memory 106 by the processor 105 and is a record of current parameters for carrying out drawing commands, such as outline colour, fill colour, line thickness and so on.

At reproducing step 603, the drawing commands for any such contravening marked content sections are extracted. The extracted marked content is reproduced, under execution of the processor 105, by displaying the marked content in isolation from other content at a display size that does not contravene an authoring intent data structure associated with the marked content. During step 603, the graphics state that was stored for a particular contravening marked content section during step 602 is re-established from the stored record for the particular contravening marked content. The drawing commands for the marked content section are carried out with the appropriate drawing parameters.

The method 700 of processing page content of a document page, as executed at processing step 602, will now be described with reference to FIG. 7. The method 700 may be implemented as one or more software code modules of the software application 133 resident on the hard disk drive 110 and being controlled in its execution by the processor 105. As described above, the document page to be displayed includes at least one marked content section.

The method 700 begins at processing step 701, in which drawing commands not belonging to a marked content section are processed. The processing performed at step 701 yields drawing operations to be performed and shapes, text and image graphical objects to be contributed to the output form of the page being processed.

At step receiving step 702, a command comprising an identifier identifying the start of a marked content section is received, under execution of the processor 105. The received command may be referred to as a “start of marked content section command” The received command indicates that the drawing commands following the identifier, up to a matching identifier for the end of the marked content section, are drawing commands subject to one or more output constraints.

After having identified the start of the marked content section, at processing step 703, an authoring intent data structure corresponding to the marked content section is processed under execution of the processor 105. The authoring intent data structure may be stored in the memory 106. The authoring intent data structure comprises a set of output constraints. The authoring intent data structure associated with the identified marked content section may be determined using a data structure or reference associated with the start of the marked content section command.

At processing step 704, a next drawing command within the marked content section is processed, under execution of the processor 105. The processing of the drawing command at step 704 yields a drawn graphical object that contributes to the output form of the page being processed, and having a size and location on the output medium.

The method 700 then proceeds to processing step 705, where each of the per-object output constraints defined in the associated authoring intent data structure are tested under execution of the processor 105. As described above, per-object constraints tested at step 705 may include one or more of a text size of a graphical object, a feature size of a graphical object, or a bitmap sampling rate of a graphical object.

Then at expanding step 706, aggregate bounds of the graphical objects produced by the drawing commands in the marked content section are expanded to include the graphical object produced by the drawing command from step 704. Details of the expanded aggregate bounds may be stored in the memory 106.

At decision step 707, if an end marked content command is encountered following the drawing command processed in step 704, then the method 700 proceeds to step testing step 708. Otherwise, the method 700 returns to step 704.

At step 708, occurring after the end of the marked content section is determined, the whole-section output constraints of the authoring intent data structure associated with the marked content section are tested under execution of the processor 105. The whole-section output constraints are the constraints that refer to aspects of the combined size of all of the drawing objects produced by drawing commands in the marked content section. The whole-section output constraints are tested at step 708 by comparing the aggregate bounds determined at step 705.

Then, at decision step 709, if any output constraints have failed (at either step 708 for the current marked content section, or at step 705 for any individual graphic object produced by a drawing command with the current marked content section), then the method 700 flows to identifying step 710. Otherwise, the method 700 proceeds to looping step 711. At step 710, the marked content section is flagged (or identified) as contravening the authoring intent data structure.

After step 709 or 710, the method 700 flows to looping step 711. As previously described in one arrangement, constraints tested at step 708 include an aggregate size of a marked content section, a scale-down ratio of a marked content section, and/or a subtended viewing angle of a marked content section.

At looping step 711, if the end of page content of the processed page has been processed, then the method 700 concludes. Otherwise, the method 700 returns to step 701 where the remainder of the drawing commands in the page content of the processed page are executed as long as the end of page content has not been reached. In doing so, the method 700 may encounter and process additional marked content sections, each with their own associated authoring intent data structures and associated output constraints.

In testing the output constraints of the authoring intent data structure at step 705, each output constraint is applied to the currently processed drawing command of step 704 only if that constraint is applicable to the type of graphical object produced by that drawing command. For example, an output constraint governing the allowable point size of text will be tested for drawing commands that produce text objects.

When performing a step in which displayed output is tested for violating one or more output constraints, the testing is performed by comparing a determined actual displayed size with a measurement expressed as an output constraint. For example, an aggregate size output constraint is tested by determining a total size for the included displayed graphical objects, which is derived as a physical measurement by a known mapping of device-specific co-ordinates of objects to physical locations on the display medium.

In another example, a subtended viewing angle output constraint is tested by determining a subtended viewing angle of a displayed object based on a derived physical display size of that object, and a known, idealised or assumed distance from the screen to a viewer. The subtended viewing angle of the displayed object is determined utilising a known mapping of device-specific object co-ordinates to physical locations on a projection screen.

Reproducing step 603 of the method 600 of FIG. 6 may be implemented using a number of different methods, leading to a number of arrangements that differ in the manner by which identified page content is reproduced (e.g., displayed, redisplayed, projected on the display 114).

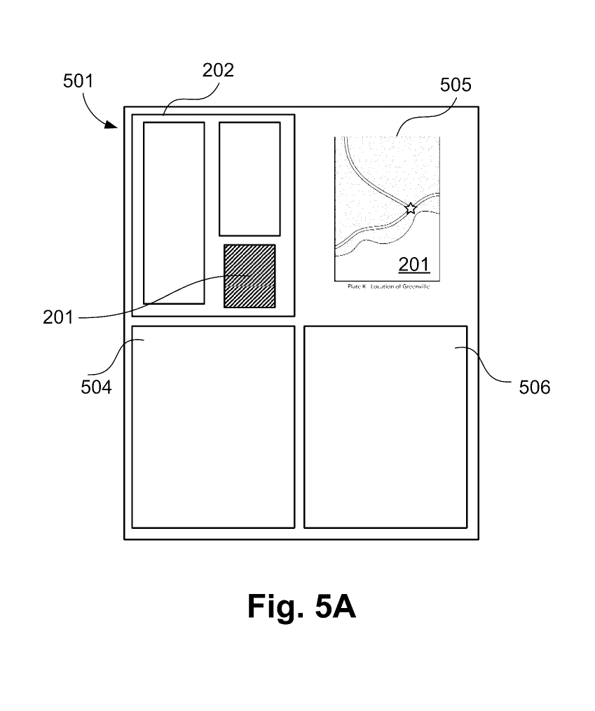

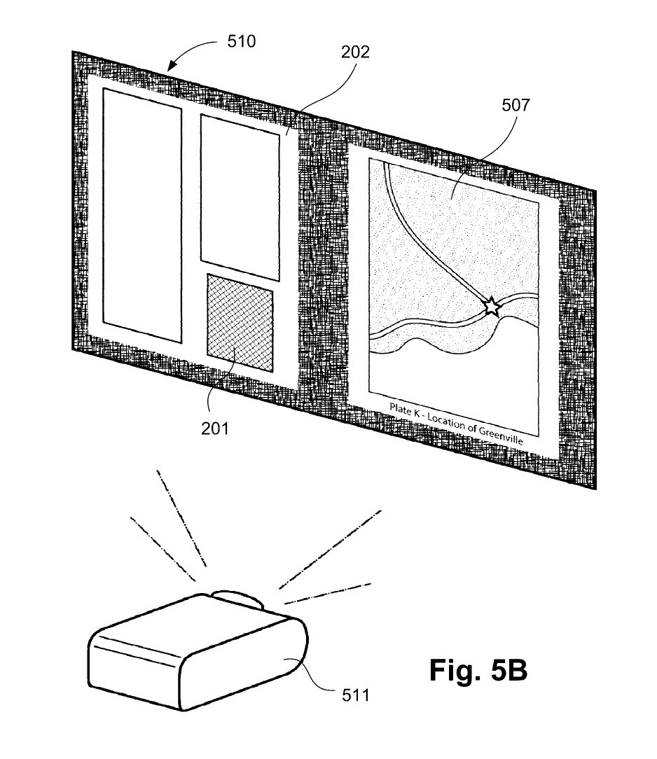

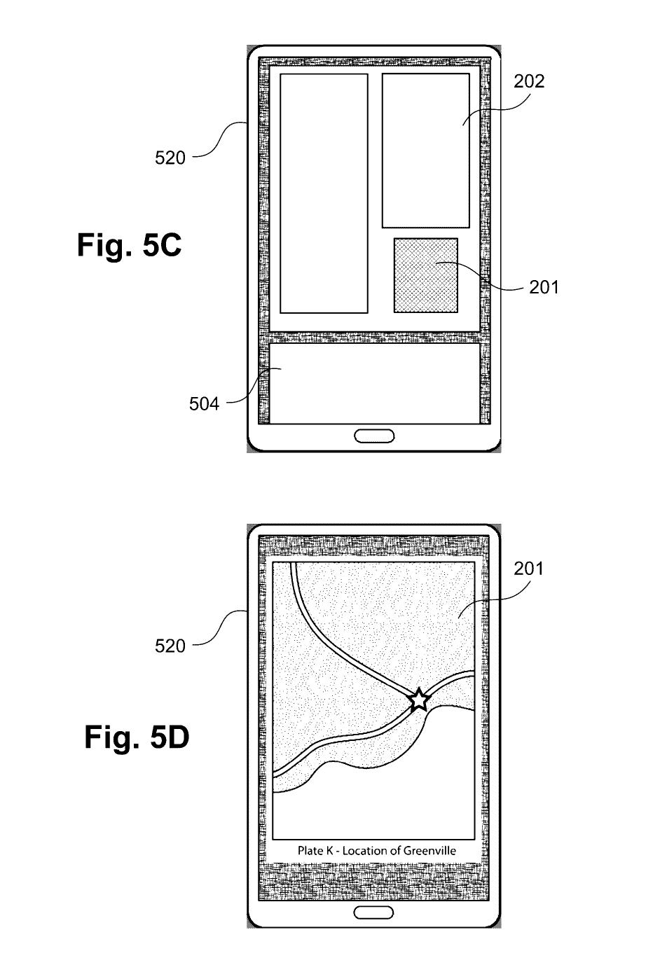

FIG. 5A shows a four-up output page 501 upon which several document page images have been imposed, for example, in accordance with user input. In the example of FIG. 5A, the page 501 is printed. As described below, page content 201 is accompanied by the document page 202 reproduced on an output medium in accordance with user input.

As seen in FIG. 5A, an image of document page 202 of FIG. 2A is imposed on the printed output page 501, occupying one page slot. At the printed size of FIG. 5A, the page content 201 appears at a reduced size which contravenes the output constraints recorded for the page content 201. The page content 201, being a single semantic unit of content, is indicated by virtue of being recorded as a marked content section in a page content stream for the page 202 (i.e., the PDL representation of the page 202). The content corresponding to the single semantic unit is reproduced (e.g., displayed or redisplayed on the display 114, printed on an output medium) in an auxiliary imposition, in isolation from the rest of the page content (i.e., in isolation from foreground or background objects including objects that overlap the single semantic unit of content as indicated as a marked content section in the page content stream for the page 202). The auxiliary imposition of the isolated content item occurs in an allocated page slot, at position 505 in the example of FIG. 5A. The isolated content item is displayed at a size which is allowable by the output constraint recorded for the content item 201.

In the example of FIG. 5A, further pages 504 and 506 are displayed at the same reduced imposition size but do not have content that contravenes any associated output constraints.

By selecting a four-up printing schema with auxiliary imposition of page content, the document page 202 in the example of FIG. 5A can be output in a way that reduces the number of printed paper sheets that are required for printing, with a corresponding reduction in the consumption of printer toner. Simultaneously, all page content is presented at a size at which the document author has deemed the content to be legible or otherwise suitable for its intended process. In contrast with methods that would prohibit four-up page imposition, the entire three page example document can be emitted on a single printed sheet. If, instead, the presence of some subset of the document content entirely prohibited the page from being eligible for four-up printing, the example page 202 is emitted in one-up formatting, occupying the entirety of a first printed output page surface, with subsequent document pages occupying one or more further output page surfaces.

In one arrangement, n-up setting received as user input may be considered as a downscaling factor. The downscaling factor defines a layout having a plurality of openings to reproduce a number of pages of the document on a single page of an output medium. For example, an output medium is subdivided in accordance with the layout into n even slots or openings, one for a single page of the document, for example, as shown in FIG. 2C or FIG. 5A. In such an arrangement, a page of the document containing the marked content is downscaled in accordance with the downscaling factor to produce a downscaled image. The downscaled image is then arranged in a first opening accompanied by the transformed marked content in a second opening to reproduce the document on the output medium. The marked content is transformed to satisfy the output constraint and to fit into the opening window identified in the vicinity of the first opening.

The methods described above may also be used in an arrangement in which an “n-up page imposition” setting may be determined for a given document. The n-up page imposition setting that leads to a smallest number of printed output sheets (and thus a greatest saving of paper) is determined. For the set of document pages to be printed, and a particular selection of n-up page imposition setting, it is determined how many n-up slots are utilised as auxiliary content imposition slots. For example, the number of semantic units of content that are too small for an n-up size, or a number of n-up slots that such content can be arranged into, may be determined).

In one example, a document of seven pages, printed at a 2-up page imposition setting, may require no auxiliary impositions of page content, yielding a total of four output sheets—the sheets having imposed on them pages 1 and 2, pages 3 and 4, pages 5 and 6, and page 7. The same document, printed at a 4-up page imposition setting, may require three content items to be redisplayed as auxiliary impositions, thus utilising a total of ten page slots. At a four-up page imposition setting, this corresponds to only three output sheets. At even more aggressive n-up page imposition settings, a much greater number of page content items are found to contravene their associated output constraints, yielding such a high number of auxiliary impositions that the total number of output sheets bears no further improvement. In the present example for the seven page document, 4-up is selected as the setting for reducing the usage of printer consumables.

In some arrangements, adjacent n-up slots may be merged to form a larger slot, which is then utilised as an auxiliary content imposition slot.

Another arrangement of the described methods will now be described with reference to FIG. 5B, in which a projector 511 and projector screen 510 are shown. The projector 511 projects an image onto the projector screen 510. In the example of FIG. 5B, the example document page 202 of FIG. 2A is displayed. The example of FIG. 5B takes place in a viewing context in which one or more users simultaneously view a document in a shared environment such as an office meeting room, or auditorium, and document content is displayed on the projector screen 510 visible to those users. The projector screen 510 has a landscape orientation (i.e., the projector screen 510 is wider than it is tall), but the displayed document pages (e.g., 202) have a portrait orientation (i.e., the displayed document pages being taller than they are wide). If a displayed page is utilising the full width of the projector screen 510, only a subset of the page (e.g., page 202) is visible at a time. An operator controlling the presentation would need to scroll the view of the page to show other parts of the page at regular intervals. In order to avoid such constant scrolling of page content, which would be distracting to the audience, and would limit the document view to a single horizontal band of page content at any moment in time, document pages are displayed at reduced size occupying one part of the projector screen 510, as for document page 202. A remaining portion 507 of the projector screen 510 is utilised for displaying an auxiliary view of page content item 201 that is determined to contravene an output constraint as recorded in an author intent data structure associated with the page content item 201. In some arrangements, an interactive slideshow may be operated such that one or more such auxiliary views of marked content originating from the same document page and contravening the intent of the author are displayed in sequence.

A further arrangement of the described methods will now be described with reference to FIGS. 5C and 5D. In the example of FIGS. 5C and 5D, example document pages 202 and 521 are displayed within the user interface of a smartphone 520. In a first view, as seen in FIG. 5C, example document page 202, is displayed, and by means of a touch-based user interaction a scrolling action can be performed to change the view in order to display the next document page 521, and further subsequent pages. The document page 202 is displayed as large as the width of the smartphone screen allows. However, due to the small physical size of the screen, or limited spatial resolution of the display, some page elements (i.e., 201) are displayed at a size which does not conform to an output constraint associated with a marked content section set by the document author. By means of another touch-based user interaction, different to that configured to scroll through the view of document pages, the view of the document page 202 seen on smartphone 520 may be switched to a detail view as seen in FIG. 5D. In the detail view of FIG. 5D, item of marked content 201 is displayed in isolation, at a size or resolution that does conform to an associated output constraint. Other such marked content items may be shown via touch-based user interaction, including interactions for showing a previous or next item of content, or for navigating through a scrolling view of such items of content. In some arrangements, isolated views of individual marked content items are displayed in a scrolling view interspersed between their originating document pages.

In a further arrangement, a document page contains a first marked content section delineating drawing commands representing a semantic unit of page content, and a second marked content section delineating drawing commands representing a page background for the entire page. In such an arrangement, as part of reproducing step 603, a clipped region of the page background is drawn in conjunction with the redisplayed page content, as a background layer for that reproduced (e.g., displayed, printed, projected) content. The clipping region for drawing the background corresponds to the bounds as determined in step 705 of method 700. An arrangement where a clipped region of the page background is drawn in conjunction with the redisplayed page content, is advantageous in cases where the reproduced content would otherwise be illegible when displayed on a blank or default background when drawn in isolation of other page content (e.g., a page having a dark coloured background, with contrasting light coloured text graphical objects comprising a paragraph or a table of text).

In one arrangement, content may be displayed by retargeting the document content to a second reformatted document. In one such example arrangement, document pages are reformatted into a second document by performing page imposition, introducing a transformation which imposes the page images at a reduced size in the second document. Each page of the second document contains multiple page impositions of pages from the original document, yielding a document suitable for printing on a large format printing press, and subject to subsequent binding and finishing processes for producing a final printed item. Such arrangements utilise output constraints and cause auxiliary page imposition to occur for marked content items as necessary, but do not perform actual graphics rendering for display to a device.

The described methods overcome deficiencies in the prior art. The described methods provide a means for an electronic document to be expressed such that the document is device-independent, but able to be effectively represented on output media in a display size that is different to that originally encoded, while still conforming to the original intent.

### INDUSTRIAL APPLICABILITY

The arrangements described are applicable to the computer and data processing industries and particularly for image processing.

The foregoing describes only some embodiments of the present invention, and modifications and/or changes can be made thereto without departing from the scope and spirit of the invention, the embodiments being illustrative and not restrictive.

APPENDIX A

```
8 0 obj
<</Length 1554>>
stream
  q
  236 522.89 −226 300 re
  W n
  q
  /GS0 gs
  −0.0000153 300 300 0.0000153 123 522.8896484 cm
  BX /Sh0 sh EX Q
  Q
  <<
    /Constraints
    ...
  >>
  BDC
    0.663 0.384 0 0 k
    0 0 0 1 K
    /GS0 gs
    219.207 548.6 −192.437 265.546 re
    B
    q
    0 841.89 595.28 −841.89 re
    W n
    0.765 0 1 0 k
    q 1 0 0 1 219.207 672.3062 cm
    0 0 m
    −19.697 4.913 −41.473 11.063 −47.347 −10.02 c
    ...
    −192.437 141.84 1
    0 141.84 1
    h
    f
    Q
    q 1 0 0 1 219.207 672.3062 cm
    0 0 m
    −19.697 4.913 −41.473 11.063 −47.347 −10.02 c
    ...
    −192.437 141.84 1
    0 141.84 1
    0 0 1
    h
    S
    Q
    0.669 0.582 0.542 0.341 K
    5 w
    q 1 0 0 1 27 611.3896 cm
    0 0 m
    12.555 0.09 31.3 22.977 42.101 28.004 c
    ...
    S
    Q
    q 1 0 0 1 166.5 682.3896 cm
    0 0 m
    −61.022 37.274 −120.5 49.408 −120.5 131.5 c
    S
    Q
    0.176 0 0.806 0 k
    q 1 0 0 1 166 692.8096 cm
    0 0 m
    3.209 -6.502 1
    ...
    −3.209 −6.502 1
    h
    f
    Q
    0.114 0.836 0.664 0.01 K
    2 w
    q 1 0 0 1 166 692.8096 cm
    0 0 m
    3.209 −6.502 1
    ...
    −3.209 −6.502 1
    0 0 1
    h
    S
    Q
    Q
    BT
    0 0 0 1 k
    /T1_0 1 Tf
    12 0 0 12 104 674.8896 Tm
    [(Gr)10(een)13(ville)]TJ
    −2.304 −11.708 Td
    [(F)26(igur)10(e 3 − Gr)10(een)13(ville)TJ
    ET
  EMC
  q
  0 841.89 595.28 −841.89 re
  W n
  0 0.978 0.986 0 K
  3 w
  q 1 0 0 1 175.5 708.8896 cm
  0 0 m
  −49.353 0 −55.161 −57.86 −3.342 −61.649 c
  30.728 −64.14 30.874 −8.205 2 −6.5 c
  S
  Q
  Q
endstream
endobj
```

APPENDIX B

```
8 0 obj
  << /Length ... >>
stream
...
<<
  /Constraints
  <<
    /AggregateSize 2.8
    /AggregateRatio 4.2
    /FontPtSize 8
    /FeatureSize 0.06
    /BitmapSampling 1
    /SubtendedAngle 8.6
  >>
>>
BDC
  ...
EMC
...
endstream
endobj
```

1. A computer readable medium comprising a page description language data structure stored thereon, the page description language data structure comprising:
a page content stream of commands for drawing content of a document on an output medium in accordance with a user input, the page content stream having a marked content section defining marked content to be displayed on the output medium in accordance with an authoring intent; and
an authoring intent data structure associated with the marked content section to reproduce the document on the output medium based on the authoring intent and the user input, the authoring intent data structure defining an output constraint to allow the marked content to be reproduced in accordance with the authoring intent in isolation from the rest of the page content stream if the user input violates the output size constraint for the at least one marked object.

2. The computer readable medium according to claim 1, wherein the authoring intent data structure comprises a type of the output constraint for interpreting the authoring intent, the type of the output constraint being associated with a measurement on the output medium of the marked content.

3. The computer readable medium according to claim 1, wherein the authoring intent data structure comprises a value of the output constraint.

4. A method of reproducing a document defined in a page description language (PDL) data structure, the method comprising:
receiving the PDL data structure defining content of the document including marked content, the PDL data structure comprising an authoring intent data structure defining an output constraint for reproducing the marked content;
interpreting the authoring intent data structure to determine whether reproducing the marked content in accordance with received user input would violate said output constraint; and
reproducing the document including the marked content, wherein the marked content is reproduced in a form which satisfies said output constraint by processing the marked content in isolation from the other content of the document using the authoring intent data structure if reproducing the marked content violates the output constraint.

5. The method according to claim 4, wherein reproducing the marked content in isolation is enabled by retaining a graphics state at the beginning of the marked content.

6. The method according to claim 4, further comprising transforming the marked content to satisfy the output constraint.

7. The method according to claim 6, wherein the transformed marked content is accompanied by the document reproduced on an output medium in accordance with the user input.

8. The method according to claim 4, wherein the PDL data structure comprises drawing commands for producing the marked content.

9. The method according to claim 4, wherein the marked content comprises a plurality of objects.

10. The method according to claim 9, wherein the plurality of objects are modified in the reproduced marked content.

11. The method according to claim 4, wherein text described by the marked content is modified in the reproduced marked content.

12. The method according to claim 4, wherein a feature described by the PDL data structure is modified in the reproduced marked content.

13. The method according to claim 4, wherein said output constraint is represented as a size that a unit of the marked content is displayed on an output medium.

14. The method according to claim 4, wherein said output constraint is represented as a scaling ratio.

15. The method according to claim 4, wherein said output constraint is associated with a display modality.

16. The method according to claim 15, wherein the display modality is defined by a range of viewing angles.

17. The method according to claim 4, wherein said output constraint is represented as an aggregate extent on an output medium of the marked content.

18. The method according to claim 4, wherein said output constraint is represented as an aggregate subtended viewing angle on an output medium of the marked content.

19. The method according to claim 4, wherein said output constraint is a scale-down ratio of the marked content relative to an original size of marked content.

20. The method according to claim 4, wherein said output constraint is a glyph size for text of the marked content.

21. The method according to claim 4, wherein said output constraint is a line stroke size for line objects of the marked content.

22. The method according to claim 4, wherein said output constraint is a subsampling rate for displaying bitmap objects of the marked content.

23. The method according to claim 6, further comprising:
determining a downscaling factor based on the received user input, the determined downscaling factor defining a layout having a plurality of openings to reproduce a number of pages on a single page of the output medium;
downscaling a page of the document containing the marked content in accordance with the downscaling factor to produce a downscaled image;
arranging the downscaled image in a first opening accompanied by the transformed marked content in a second opening to reproduce the document on the output medium, wherein the marked content is transformed to satisfy the output constraint and to fit into the second opening identified in the vicinity of the first opening.

24. An apparatus for reproducing a document defined in a page description language (PDL) data structure, the apparatus comprising:
module for receiving the PDL data structure defining content of the document including marked content, the PDL data structure comprising an authoring intent data structure defining an output size constraint for reproducing the marked content;
module for interpreting the authoring intent data structure to determine whether reproducing the marked content in accordance with received user input would violate said output size constraint; and
module for reproducing the document including the marked content, wherein the marked content is reproduced in a form which satisfies said output size constraint by processing the marked content in isolation from the other content of the document using the authoring intent data structure if reproducing the marked content violates the output size constraint.

25. A system for reproducing a document defined in a page description language (PDL) data structure, the system comprising:
a memory for storing data and computer program;
a processor coupled to the memory for executing said compute program, said computer program comprising instructions for:
receiving the PDL data structure defining content of the document including marked content, the PDL data structure comprising an authoring intent data structure defining an output size constraint for reproducing the marked content;
interpreting the authoring intent data structure to determine whether reproducing the marked content in accordance with received user input would violate said output size constraint; and
reproducing the document including the marked content, wherein the marked content is reproduced in a form which satisfies said output size constraint by processing the marked content in isolation from the other content of the document using the authoring intent data structure if reproducing the marked content violates the output size constraint.

26. A computer readable medium having a computer program stored thereon for reproducing a document defined in a page description language (PDL) data structure, the computer program comprising:
code for receiving the PDL data structure defining content of the document including marked content, the PDL data structure comprising an authoring intent data structure defining an output size constraint for reproducing the marked content;
code for interpreting the authoring intent data structure to determine whether reproducing the marked content in accordance with received user input would violate said output size constraint; and
code for reproducing the document including the marked content, wherein the marked content is reproduced in a form which satisfies said output size constraint by processing the marked content in isolation from the other content of the document using the authoring intent data structure if reproducing the marked content violates the output size constraint.
